(19) United States
(12) Patent Application Publication
(10) Pub. No.: US 2025/0243360 A1
(43) Pub. Date: Jul. 31, 2025

(54) RESIN TUBE

(71) Applicant: KANEKA CORPORATION, Osaka-shi (JP)

(72) Inventors: Kengo FUKUSHIMA, Settsu-shi (JP); Tomoaki HASHIGUCHI, Settsu-shi (JP); Takeshi SUGIYAMA, Settsu-shi (JP)

(73) Assignee: KANEKA CORPORATION, Osaka-shi (JP)

(21) Appl. No.: 19/182,954

(22) Filed: Apr. 18, 2025

Related U.S. Application Data
(63) Continuation of application No. PCT/JP2023/036986, filed on Oct. 12, 2023.

(30) Foreign Application Priority Data
Oct. 21, 2022 (JP) 2022-168881

(51) Int. Cl. C08L 67/04; C08K 5/053; F16L 9/127

(52) U.S. Cl. CPC C08L 67/04; C08K 5/053; F16L 9/127; C08L 2203/18; C08L 2205/025; C08L 2205/06

(57) ABSTRACT

A resin tube contains poly(3-hydroxybutyrate) and a poly(3-hydroxyalkanoate) copolymer. The amount of the poly(3-hydroxybutyrate) is from 7 to 13 wt % based on 100 wt % of the total amount of the poly(3-hydroxybutyrate) and the copolymer. The copolymer may include a copolymer (A) which is a copolymer of 3-hydroxybutyrate units and other hydroxyalkanoate units and in which the proportion of the other hydroxyalkanoate units in the total amount of the 3-hydroxybutyrate units and the hydroxyalkanoate units is from 1 to 5 mol %.

### TECHNICAL FIELD

The present invention relates to a resin tube containing a poly(3-hydroxyalkanoate) resin.

### BACKGROUND ART

In recent years, global attempts have been launched to reduce marine pollution or shift to a recycle-oriented society, and resins of biological origin or resins having marine degradability are under active research and development. Poly(3-hydroxyalkanoate) resins are attracting interest as bio-based, marine-degradable resins.

Poly(3-hydroxyalkanoate) resins are thermoplastic polyesters produced and accumulated as energy storage substances in the cells of many kinds of microorganisms. These resins are biodegradable in seawater as well as in soil and thus are drawing attention.

Patent Literature 1 discloses a resin tube containing at least two types of poly(3-hydroxyalkanoate) resins and having high impact resistance.

### CITATION LIST

### Patent Literature

PTL 1: WO 2022/009717

### SUMMARY OF INVENTION

### Technical Problem

The production of previously-reported poly(3-hydroxyalkanoate) resin-containing tubes suffers from low productivity due to a slow solidification speed during extrusion molding. For instance, Examples of Patent Literature 1 disclose resin tube production performed at a low speed of 10 m/min.

In view of the above circumstances, the present invention aims to provide a poly(3-hydroxyalkanoate) resin-containing tube that can be produced at high productivity.

### Solution to Problem

As a result of intensive studies with the goal of solving the above problem, the present inventors have found that a resin tube having a good appearance can be produced at high productivity by using given proportions of poly(3-hydroxybutyrate) and a poly(3-hydroxyalkanoate) copolymer as poly(3-hydroxyalkanoate) resins. Based on this finding, the inventors have completed the present invention.

Specifically, the present invention relates to a resin tube containing poly(3-hydroxybutyrate) and a poly(3-hydroxyalkanoate) copolymer, wherein
an amount of the poly(3-hydroxybutyrate) is from 7 to 13 wt % based on 100 wt % of a total amount of the poly(3-hydroxybutyrate) and the poly(3-hydroxyalkanoate) copolymer.

### Advantageous Effects of Invention

The present invention can provide a poly(3-hydroxyalkanoate) resin-containing tube that can be produced at high productivity. The resin tube has a good appearance with reduced gel formation.

### DESCRIPTION OF EMBODIMENTS

Hereinafter, an embodiment of the present invention will be described. The present invention is not limited to the embodiment described below.

A resin tube according to one embodiment of the present invention contains a poly(3-hydroxyalkanoate) resin including poly(3-hydroxybutyrate) and a poly(3-hydroxyalkanoate) copolymer.

### Poly(3-Hydroxybutyrate)

The poly(3-hydroxybutyrate) refers to a homopolymer of 3-hydroxybutyrate but may contain a small amount of monomer units other than 3-hydroxybutyrate units. Specifically, it is preferable that the proportion of 3-hydroxybutyrate units in the total constituent monomer units of the poly(3-hydroxybutyrate) be from more than 99 mol % to 100 mol %. The inclusion of the poly(3-hydroxybutyrate) in the resin tube can increase the solidification speed of the total poly(3-hydroxyalkanoate) resin, thus leading to improved resin tube productivity.

The monomer units other than 3-hydroxybutyrate units in the poly(3-hydroxybutyrate) are not limited to a particular type and may be any kind of monomer units copolymerizable with 3-hydroxybutyrate units. Examples include 3-hydroxyalkanoate units other than 3-hydroxybutyrate units and hydroxyalkanoate units (such as 4-hydroxyalkanoate units) other than 3-hydroxyalkanoate units. Specific examples include units described later in relation to the poly(3-hydroxyalkanoate) copolymer.

The amount of the poly(3-hydroxybutyrate) is from 7 to 13 wt % based on 100 wt % of the total amount of the poly(3-hydroxybutyrate) and the poly(3-hydroxyalkanoate) copolymer. The fact that the amount of the poly(3-hydroxybutyrate) is 7 wt % or more contributes to an increase in the solidification speed of the total poly(3-hydroxyalkanoate) resin, thus leading to improved resin tube productivity and allowing for high-speed molding of the resin tube. The amount is preferably more than 7 wt %, more preferably 8 wt % or more, even more preferably 9 wt % or more, still even more preferably 10 wt % or more, and particularly preferably 11 wt % or more.

If the amount of the poly(3-hydroxybutyrate) is extremely large, the resin tube is likely to suffer from the formation of large-sized gels, and such gels could cause a trouble such as clogging during extrusion molding or impair the appearance of the resin tube. Controlling the amount to 13 wt % or less can reduce the gel formation. The amount is preferably less than 13 wt % and more preferably 12.5 wt % or less.

### Poly(3-Hydroxyalkanoate) Copolymer

The poly (3-hydroxyalkanoate) copolymer is a copolymer having at least one type or two or more types of 3-hydroxyalkanoate units.

The 3-hydroxyalkanoate units are preferably represented by the following formula (1).

[—CHR—CH₂—CO—O—] ( 1)

In the formula (1), R is an alkyl group represented by CₚH₂ₚ₊₁, and p is an integer from 1 to 15. Examples of R include linear or branched alkyl groups such as methyl, ethyl, propyl, methylpropyl, butyl, isobutyl, t-butyl, pentyl, and hexyl groups. The integer p is preferably from 1 to 10 and more preferably from 1 to 8.

The poly(3-hydroxyalkanoate) copolymer is particularly preferably a microbially produced poly(3-hydroxyalkanoate) copolymer. In the microbially produced poly(3-hydroxyalkanoate) copolymer, all of the 3-hydroxyalkanoate units are contained as (R)-3-hydroxyalkanoate units.

The poly(3-hydroxyalkanoate) copolymer preferably contains 50 mol % or more, more preferably 60 mol % or more, even more preferably 70 mol % or more, of 3-hydroxyalkanoate units (in particular, the units represented by the formula (1)) in the total structural units (monomer units). The poly(3-hydroxyalkanoate) copolymer may contain only two or more types of 3-hydroxyalkanoate units as polymer structural units or may contain other units (e.g., 4-hydroxyalkanoate units) in addition to one type or two or more types of 3-hydroxyalkanoate units.

The poly(3-hydroxyalkanoate) copolymer is preferably a copolymer containing 3-hydroxybutyrate (hereinafter also referred to as “3HB”) units and other hydroxyalkanoate units. Preferably, all of the 3-hydroxybutyrate units are (R)-3-hydroxybutyrate units.

The other hydroxyalkanoate units may be 3-hydroxyalkanoate units other than 3HB units or may be hydroxyalkanoate units (e.g., 4-hydroxyalkanoate units) other than 3-hydroxyalkanoate units. The other hydroxyalkanoate units may include only one type of hydroxyalkanoate units or may include two or more types of hydroxyalkanoate units.

Specific examples of the poly(3-hydroxyalkanoate) copolymer include poly(3-hydroxybutyrate-co-3-hydroxypropionate), poly(3-hydroxybutyrate-co-3-hydroxyvalerate) abbreviated as “P3HB3HV”, poly(3-hydroxybutyrate-co-3-hydroxyvalerate-3-hydroxyhexanoate), poly(3-hydroxybutyrate-co-3-hydroxyhexanoate) abbreviated as “P3HB3HH”, poly(3-hydroxybutyrate-co-3-hydroxyheptanoate), poly(3-hydroxybutyrate-co-3-hydroxyoctanoate), poly(3-hydroxybutyrate-co-3-hydroxynonanoate), poly(3-hydroxybutyrate-co-3-hydroxydecanoate), poly(3-hydroxybutyrate-co-3-hydroxyundecanoate), and poly(3-hydroxybutyrate-co-4-hydroxybutyrate) abbreviated as “P3HB4HB”. In particular, in terms of factors such as the resin tube productivity and the mechanical properties of the resin tube, poly(3-hydroxybutyrate-co-3-hydroxyhexanoate) or poly(3-hydroxybutyrate-co-4-hydroxybutyrate) is preferred, and poly(3-hydroxybutyrate-co-3-hydroxyhexanoate) is particularly preferred.

In terms of the resin tube productivity and the mechanical properties of the resin tube, the poly(3-hydroxyalkanoate) copolymer preferably includes at least two types of poly(3-hydroxyalkanoate) copolymers differing in crystallinity and more preferably includes at least two types of poly (3-hydroxyalkanoate) copolymers differing in the types and/or proportions of the constituent monomers.

Specifically, the poly(3-hydroxyalkanoate) copolymer preferably includes a copolymer (A) which is a copolymer of 3-hydroxybutyrate units and other hydroxyalkanoate units and in which the proportion of the other hydroxyalkanoate units in the total amount of the 3-hydroxybutyrate units and the other hydroxyalkanoate units is from 1 to 5 mol %.

Preferably, the poly (3-hydroxyalkanoate) copolymer further includes, in addition to the copolymer (A), a copolymer (B) which is a copolymer of 3-hydroxybutyrate units and other hydroxyalkanoate units and in which the proportion of the other hydroxyalkanoate units in the total amount of the 3-hydroxybutyrate units and the other hydroxyalkanoate units is 24 mol % or more.

Preferably, the poly(3-hydroxyalkanoate) copolymer further includes, in addition to the copolymer (A) and/or the copolymer (B), a copolymer (C) which is a copolymer of 3-hydroxybutyrate units and other hydroxyalkanoate units and in which the proportion of the other hydroxyalkanoate units in the total amount of the 3-hydroxybutyrate units and the other hydroxyalkanoate units is from 6 to less than 24 mol %.

The copolymer (A) is a high-crystallinity poly(3-hydroxyalkanoate) resin, while the copolymer (B) is a low-crystallinity poly (3-hydroxyalkanoate) resin. The copolymer (C) is a middle-crystallinity poly(3-hydroxyalkanoate) resin whose crystallinity is intermediate between those of the copolymers (A) and (B).

In general, high-crystallinity poly(3-hydroxyalkanoate) resins are superior in terms of productivity but have poor mechanical properties, while low-crystallinity poly(3-hydroxyalkanoate) resins have good mechanical properties although being inferior in terms of productivity. The combined use of the two or three types of resins mentioned above makes it possible to obtain a resin tube excellent in terms of the balance between productivity and mechanical properties.

The proportion of the other hydroxyalkanoate units in the copolymer (A) is from 1 to 5 mol % based on 100 wt % of the total amount of the 3-hydroxybutyrate units and the other hydroxyalkanoate units constituting the copolymer (A). In terms of the resin tube productivity, the proportion of the other hydroxyalkanoate units is preferably at least 2 mol %. The proportion is preferably up to 4 mol %.

The copolymer (A) is preferably poly(3-hydroxybutyrate-co-3-hydroxyhexanoate) or poly(3-hydroxybutyrate-co-4-hydroxybutyrate) and more preferably poly(3-hydroxybutyrate-co-3-hydroxyhexanoate).

The proportion of the other hydroxyalkanoate units in the copolymer (B) is 24 mol % or more based on 100 wt % of the total amount of the 3-hydroxybutyrate units and the other hydroxyalkanoate units constituting the copolymer (B). In terms of the strength of the resin tube, the proportion of the other hydroxyalkanoate units is preferably at least 26 mol % and more preferably at least 28 mol %. In terms of the copolymer (B) productivity, the proportion is preferably up to 99 mol %, more preferably up to 50 mol %, even more preferably up to 40 mol %, and particularly preferably up to 30 mol %.

The copolymer (B) is preferably poly(3-hydroxybutyrate-co-3-hydroxyhexanoate) or poly(3-hydroxybutyrate-co-4-hydroxybutyrate) and more preferably poly(3-hydroxybutyrate-co-3-hydroxyhexanoate).

The proportions in which the copolymers (A) and (B) are used are not limited to particular ranges. In terms of the copolymer (B) productivity and the balance between the resin tube productivity and the mechanical strength of the resin tube, a value obtained by dividing the weight fraction of the copolymer (A) in the total amount of the poly(3-hydroxybutyrate) and the poly(3-hydroxyalkanoate) copolymer by the weight fraction of the copolymer (B) in the total amount is preferably from 1.5 to 4.5. This value is preferably at least 2.0. The value is preferably up to 4.0 and more preferably up to 3.5.

The proportion of the other hydroxyalkanoate units in the copolymer (C) is from 6 to less than 24 mol % based on 100 wt % of the total amount of the 3-hydroxybutyrate units and the other hydroxyalkanoate units constituting the copolymer (C). In terms of the poly(3-hydroxyalkanoate) copolymer productivity and the resin tube productivity, the proportion of the other hydroxyalkanoate units is preferably up to 20 mol % and more preferably up to 15 mol %. The proportion is preferably at least 8 mol % and more preferably at least 10 mol %.

The copolymer (C) is preferably poly(3-hydroxybutyrate-co-3-hydroxyhexanoate) or poly(3-hydroxybutyrate-co-4-hydroxybutyrate) and more preferably poly(3-hydroxybutyrate-co-3-hydroxyhexanoate).

The proportion of the copolymer (C) to the total amount of the copolymers (A), (B), and (C) is preferably from 5 to 45 wt % in terms of the balance between the copolymer or resin tube productivity and the mechanical properties of the copolymer or resin tube. Controlling the proportion of the copolymer (C) to 5 wt % or more can lead to good productivity. Controlling the proportion of the copolymer (C) to 45 wt % or less can ensure an improvement in the mechanical properties of the resin tube, enabling the resin tube to have good impact resistance. The proportion is preferably at least 10 wt %. The proportion is preferably up to 40 wt %, more preferably up to 30 wt %, and even more preferably up to 25 wt %.

In terms of ensuring both the strength of the resin tube and the resin tube productivity, the average content ratio between 3-hydroxybutyrate units and other hydroxyalkanoate units (3-hydroxybutyrate units/other hydroxyalkanoate units) in the total monomer units constituting the total poly (3-hydroxyalkanoate) resin contained in the resin tube is preferably from 93/7 to 80/20 (mol %/mol%), more preferably from 92/8 to 81/19 (mol %/mol%), even more preferably 90/10 to 82/18 (mol %/mol%), and still even more preferably from 88/12 to 82/18 (mol %/mol%).

The average content ratio between different monomer units in the total monomer units constituting the total poly(3-hydroxyalkanoate) resin can be determined by a method known to those skilled in the art, such as a method described in paragraph [0047] of WO 2013/147139. The average content ratio refers to a molar ratio between different monomer units in the total monomer units constituting the total poly(3-hydroxyalkanoate) resin and particularly refers to a molar ratio between different monomer units contained in the total composition composed of the poly(3-hydroxybutyrate) and the poly(3-hydroxyalkanoate) copolymer.

The weight-average molecular weight of the poly(3-hydroxyalkanoate) resin is not limited to a particular range. In terms of ensuring both the strength of the resin tube and the resin tube productivity, the weight-average molecular weight is preferably from 20×10⁴ to 200×10⁴, more preferably from 25×10⁴ to 150×10⁴, and even more preferably from 30×10⁴ to 100×10⁴.

The weight-average molecular weight of each of the poly(3-hydroxybutyrate), the copolymer (A), the copolymer (B), and the copolymer (C) is not limited to a particular range either. In terms of ensuring both the strength of the resin tube and the resin tube productivity, the weight-average molecular weight of each of the poly(3-hydroxybutyrate) and the copolymer (A) is preferably from 20×10⁴ to 100×10⁴, more preferably from 22×10⁴ to 80×10⁴, and even more preferably from 25×10⁴ to 70×10⁴. In terms of ensuring both the strength of the resin tube and the resin tube productivity, the weight-average molecular weight of each of the copolymers (B) and (C) is preferably from 20×10⁴ to 250×10⁴, more preferably from 25×10⁴ to 230×10⁴, and even more preferably from 30×10⁴ to 200×10⁴.

The weight-average molecular weight of the poly(3-hydroxyalkanoate) resin, the poly(3-hydroxybutyrate), the copolymer (A), the copolymer (B), or the copolymer (C) can be measured as a polystyrene-equivalent molecular weight by gel permeation chromatography (HPLC GPC system manufactured by Shimadzu Corporation) using a chloroform solution. The column used in the gel permeation chromatography may be any suitable column for weight-average molecular weight measurement.

The method for producing the poly(3-hydroxyalkanoate) resin is not limited to a particular technique, and may be a production method using chemical synthesis or a microbial production method. A microbial production method is preferred. The microbial production method used can be any known method. Known examples of bacteria that produce copolymers of 3-hydroxybutyrate with other hydroxyalkanoates include Aeromonas caviae which is a P3HB3HV- and P3HB3HH-producing bacterium and Alcaligenes eutrophus which is a P3HB4HB-producing bacterium. In particular, in order to increase the P3HB3HH productivity, Alcaligenes eutrophusAC32 (FERM BP-6038; see T. Fukui, Y. Doi, J. Bacteriol., 179, pp. 4821-4830 (1997)) incorporating a P3HA synthase gene is more preferred. Such a microorganism is cultured under suitable conditions to allow the microorganism to accumulate P3HB3HH in its cells, and the microbial cells accumulating P3HB3HH are used. Instead of the above microorganisms, a genetically modified microorganism incorporating any suitable poly(3-hydroxyalkanoate) resin synthesis-related gene may be used depending on the poly(3-hydroxyalkanoate) resin to be produced. The culture conditions including the type of the culture substrate may be optimized depending on the poly (3-hydroxyalkanoate) resin to be produced.

The method for obtaining a blend of two or more poly(3-hydroxyalkanoate) resins is not limited to a particular technique, and such a blend may be obtained by microbial production or chemical synthesis. Alternatively, a blend of two or more resins may be obtained by melting and kneading the two or more resins by means such as an extruder, a kneader, a Banbury mixer, or a roll mill or may be obtained by dissolving and mixing the two or more resins in a solvent and drying the mixture.

### Additional Resin

The resin tube according to the present disclosure may contain an additional resin other than poly(3-hydroxyalkanoate) resins to the extent that the additional resin does not diminish the effect of the invention. Examples of the additional resin include: aliphatic polyester resins such as polybutylene succinate adipate, polybutylene succinate, polycaprolactone, and polylactic acid; and aliphatic-aromatic polyester resins such as polybutylene adipate terephthalate, polybutylene sebacate terephthalate, and polybutylene azelate terephthalate. The resin tube may contain only one additional resin or two or more additional resins.

The amount of the additional resin is not limited to a particular range but preferably 30 parts by weight or less, more preferably 20 parts by weight or less, even more preferably 10 parts by weight or less, and particularly preferably 5 parts by weight or less per 100 parts by weight of the total amount of the poly(3-hydroxyalkanoate) resin (which refers to the total amount of the (poly(3-hydroxybutyrate) and the poly(3-hydroxyalkanoate) copolymer); the same applies hereinafter). The amount of the additional resin may be 1 part by weight or less. The lower limit of the amount of the additional resin is not limited to a particular value, and the amount of the additional resin may be 0 part by weight.

### Plasticizer

The resin tube according to the present disclosure preferably contains a plasticizer in addition to the poly(3-hydroxyalkanoate) resin. The addition of the plasticizer can improve the resin tube productivity.

The plasticizer is not limited to a particular compound. In terms of the compatibility with the poly(3-hydroxyalkanoate) resin, an ester compound having an ester bond in the molecule is preferably used as the plasticizer.

Examples of ester compounds that can be used as the plasticizer include modified glycerin compounds, dibasic ester compounds, adipic ester compounds, polyether ester compounds, benzoic ester compounds, citric ester compounds, isosorbide ester compounds, and polycaprolactone compounds. Among these, modified glycerin ester compounds, dibasic ester compounds, adipic ester compounds, polyether ester compounds, and isosorbide ester compounds are preferred. One of the ester compounds as mentioned above may be used alone, or two or more thereof may be used in combination. When two or more ester compounds are used in combination, the mix proportions of the ester compounds can be adjusted as appropriate.

Preferred examples of the modified glycerin compounds include glycerin ester compounds. Glycerin ester compounds that can be used include monoesters, diesters, and triesters of glycerin. In terms of the compatibility with the poly(3-hydroxyalkanoate) resin, triesters of glycerin are preferred. Among the triesters of glycerin, glycerin diacetomonoesters are particularly preferred. Specific examples of the glycerin diacetomonoesters include glycerin diacetomonolaurate, glycerin diacetomonooleate, glycerin diacetomonostearate, glycerin diacetomonocaprylate, and glycerin diacetomonodecanoate. Examples of such modified glycerin compounds include “RIKEMAL” PL series and “BIOCIZER” of Riken Vitamin Co., Ltd.

Specific examples of the dibasic ester compounds include dibutyl adipate, diisobutyl adipate, bis(2-ethylhexyl) adipate, diisononyl adipate, diisodecyl adipate, bis[2-(2-butoxyethoxy)ethyl] adipate, bis[2-(2-butoxyethoxy)ethyl] adipate, bis(2-ethylhexyl) azelate, dibutyl sebacate, bis(2-ethylhexyl) sebacate, diethyl succinate, and mixed dibasic ester compounds.

Examples of the adipic ester compounds include diethylhexyl adipate, dioctyl adipate, and diisononyl adipate.

Examples of the polyether ester compounds include polyethylene glycol dibenzoate, polyethylene glycol dicaprylate, and polyethylene glycol diisostearate.

Among the ester compounds as mentioned above, the modified glycerin compounds are preferred in terms of cost, high utility, and high biomass level. In particular, in view of contact of the resin tube with foods, glycerin triesters are more preferred, glycerin diacetomonoesters are even more preferred, and glycerin diacetomonolaurate is particularly preferred.

The amount of the plasticizer can be set as appropriate in view of the moldability and strength of the resin tube. Preferably, the amount of the plasticizer is from 0.1 to 10 parts by weight per 100 parts by weight of the total amount of the poly(3-hydroxyalkanoate) resin. The amount of the plasticizer is preferably at least 1 part by weight, more preferably at least 2 parts by weight, and even more preferably at least 3 parts by weight. The amount of the plasticizer is preferably up to 8 parts by weight and more preferably up to 6 parts by weight.

The proportion of the plasticizer to the total amount of the copolymer (B) and the plasticizer is preferably from 12 to 30 wt % in terms of the moldability and strength of the resin tube. When the proportion is in this range, the addition of the plasticizer can provide a more significant effect since the plasticizer is incorporated into the copolymer (B) which is a low-crystallinity resin and thus increases the mobility of the polymer chain. The proportion of the plasticizer is preferably at least 15 wt %. The proportion of the plasticizer is preferably up to 25 wt % and more preferably up to 22 wt %.

### Additives

The resin tube according to the present disclosure may contain additives to the extent that the additives do not diminish the effect of the invention. Examples of the additives include a nucleating agent, a lubricant, a plasticizer, an antistatic agent, a flame retardant, a conductive additive, a heat insulator, a crosslinking agent, an antioxidant, an ultraviolet absorber, a colorant, an inorganic filler, an organic filler, and a hydrolysis inhibitor, and these additives can be used depending on the intended purpose. Biodegradable additives are particularly preferred.

Examples of the nucleating agent include: sugar alcohols such as pentaerythritol, galactitol, and mannitol; orotic acid; aspartame; cyanuric acid; glycine; zinc phenylphosphonate; and boron nitride. Among these, sugar alcohols are preferred because they are particularly superior in the accelerating effect on the crystallization of the poly(3-hydroxyalkanoate) resin, and pentaerythritol is particularly preferred. One nucleating agent may be used alone or two or more nucleating agents may be used. The proportions of the nucleating agents used can be adjusted as appropriate depending on the intended purpose.

The amount of the nucleating agent used is not limited to a particular range but preferably from 0.1 to 5 parts by weight, more preferably from 0.5 to 3 parts by weight, and even more preferably from 0.7 to 1.5 parts by weight per 100 parts by weight of the total amount of the poly(3-hydroxyalkanoate) resin. One nucleating agent may be used alone or two or more nucleating agents may be used. The proportions of the nucleating agents used can be adjusted as appropriate depending on the intended purpose.

The resin tube according to the present disclosure may contain substantially no sugar alcohol such as pentaerythritol. The expression “contain substantially no sugar alcohol” is intended to mean that the amount of any sugar alcohol is less than 0.1 parts by weight per 100 parts by weight of the total amount of the poly(3-hydroxyalkanoate) resin. The amount may be less than 0.01 parts by weight. In the present embodiment, the use of the poly(3-hydroxybutyrate) and the poly(3-hydroxyalkanoate) copolymer in given proportions can improve the resin tube productivity even when substantially no sugar alcohol is contained as a nucleating agent. When substantially no sugar alcohol is contained, it is preferable to use the lubricant as described below.

Examples of the lubricant include behenamide, oleamide, erucamide, stearamide, palmitamide, N-stearyl behenamide, N-stearyl erucamide, ethylene bis(stearamide), ethylene bis(oleamide), ethylene bis(erucamide), ethylene bis(lauramide), ethylene bis(capramide), p-phenylene bis(stearamide), and a polycondensation product of ethylenediamine, stearic acid, and sebacic acid. Among these, behenamide and erucamide are preferred because they are particularly superior in the lubricating effect on the poly(3-hydroxyalkanoate) resin.

The amount of the lubricant used is not limited to a particular range but preferably from 0.01 to 5 parts by weight, more preferably from 0.05 to 3 parts by weight, and even more preferably from 0.1 to 1.5 parts by weight per 100 parts by weight of the total amount of the poly(3-hydroxyalkanoate) resin. One lubricant may be used alone, or two or more lubricants may be used. The proportions of the lubricants used can be adjusted as appropriate depending on the intended purpose.

The term “tube” as used herein refers to a hollow, slender, cylindrical molded article having a wall that has a generally constant thickness and that is generally circular in cross-section. The tube can be used as, but is not limited to, a straw or pipe.

In the case where the resin tube according to the present disclosure is used as a straw, the wall thickness of the resin tube is preferably from 0.01 to 0.6 mm, more preferably from 0.05 to 0.5 mm, and even more preferably from 0.1 to 0.4 mm so that the straw may avoid collapsing when a beverage is sucked through the straw, that the straw may be flexible enough to resist breakage, that the straw may cause little injury when its end contacts a body part such as a fingertip, and that the straw may be quickly biodegraded in seawater.

In the case where the resin tube according to the present disclosure is used as a straw, the outer diameter of the resin tube is not limited to a particular range. In terms of the ease of use of the straw for drinking a beverage, the outer diameter is preferably from 2 to 10 mm, more preferably from 4 to 8 mm, and even more preferably from 5 to 7 mm.

In the case where the resin tube according to the present disclosure is used as a pipe, the wall thickness of the resin tube can be set as appropriate by those skilled in the art. The wall thickness is preferably from 0.7 to 10 mm and more preferably from 1 to 8 mm. The pipe can be suitably used for purposes such as cultivation or catching of seafood products.

The resin tube according to the present disclosure is generally circular in cross-section. The cross-sectional shape is preferably close to a true circle in terms of the usability of the resin tube as a straw or pipe. Thus, the degree of flattening of the cross-sectional shape of the tube, calculated by the formula [100 ×(maximum outer diameter−minimum outer diameter)/maximum outer diameter], is preferably 10% or less, more preferably 8% or less, even more preferably 5% or less, and still even more preferably 3% or less. When the degree of flattening is 0%, this means that the cross-sectional shape is a true circle.

The length of the resin tube according to the present disclosure is not limited to a particular range. In the case where the resin tube is used as a straw, the length of the resin tube is preferably from 50 to 350 mm, more preferably from 70 to 300 mm, and even more preferably from 90 to 270 mm in terms of the ease of use of the straw for drinking a beverage.

The resin tube used as a straw may be a tube that has not been subjected to any secondary process or a tube that has been subjected to a secondary process such as formation of a stopper portion or corrugated portion.

The resin tube according to the present disclosure can be produced by a known method. For example, the resin tube can be produced by melting a blend of the poly(3-hydroxyalkanoate) resin and additives in an extruder, then extruding the molten blend from an annular die connected to the outlet of the extruder, and placing the extruded blend into water to solidify the blend into the shape of a tube.

In the case where the resin tube according to the present disclosure is subjected to a secondary process, the secondary process may be carried out at normal temperature or under heating. The resin tube according to the present disclosure is suitable for being subjected to a secondary process involving heating. The heating temperature in the secondary process can be set as appropriate and may be, for example, from about 100 to about 150° C.

In the following items, preferred aspects of the present disclosure are listed. The present invention is not limited to the following items.

### Item 1

A resin tube containing poly(3-hydroxybutyrate) and a poly(3-hydroxyalkanoate) copolymer, wherein
an amount of the poly(3-hydroxybutyrate) is from 7 to 13 wt % based on 100 wt % of a total amount of the poly(3-hydroxybutyrate) and the poly(3-hydroxyalkanoate) copolymer.

### Item 2

The resin tube according to item 1, wherein
the poly(3-hydroxyalkanoate) copolymer includes a copolymer (A) which is a copolymer of 3-hydroxybutyrate units and other hydroxyalkanoate units and in which a proportion of the other hydroxyalkanoate units in a total amount of the 3-hydroxybutyrate units and the other hydroxyalkanoate units is from 1 to 5 mol %.

### Item 3

The resin tube according to item 2, wherein
the poly(3-hydroxyalkanoate) copolymer further includes a copolymer (B) which is a copolymer of 3-hydroxybutyrate units and other hydroxyalkanoate units and in which a proportion of the other hydroxyalkanoate units in a total amount of the 3-hydroxybutyrate units and the other hydroxyalkanoate units is 24 mol % or more.

### Item 4

The resin tube according to item 2 or 3, wherein
the poly(3-hydroxyalkanoate) copolymer further includes a copolymer (C) which is a copolymer of 3-hydroxybutyrate units and other hydroxyalkanoate units and in which a proportion of the other hydroxyalkanoate units in a total amount of the 3-hydroxybutyrate units and the other hydroxyalkanoate units is from 6 to less than 24 mol %.

### Item 5

The resin tube according to item 3 or 4, wherein a value obtained by dividing a weight fraction of the copolymer (A) in the total amount of the poly(3-hydroxybutyrate) and the poly(3-hydroxyalkanoate) copolymer by a weight fraction of the copolymer (B) in the total amount is from 1.5 to 4.5.

### Item 6

The resin tube according to any one of items 1 to 5, further containing a plasticizer.

### Item 7

The resin tube according to item 6, wherein
a proportion of the plasticizer to a total amount of the copolymer (B) and the plasticizer is from 12 to 30 wt %.

### Item 8

The resin tube according to item 6 or 7, wherein
the plasticizer is a modified glycerin compound.

### Item 9

The resin tube according to any one of items 1 to 8, wherein
the resin tube has a wall thickness of 0.01 to 0.6 mm.

### Item 10

The resin tube according to any one of items 1 to 8, wherein
the resin tube has a wall thickness of 0.7 to 10 mm.

### EXAMPLES

Hereinafter, the present invention will be specifically described using examples. The technical scope of the present invention is not limited by the examples given below.

Listed below are materials used in Examples and Comparative Examples.

### Poly(3-Hydroxyalkanoate) Resins

PHB: Poly(3-hydroxybutyrate) (weight-average molecular weight=30×10⁴ g/mol)

This resin was produced according to a method described in Comparative Example 1 of WO 2004/041936.

P3HB3HH-3: P3HB3HH (average content ratio 3HB/3HH=97.1/2.9 (mol %/mol%), weight-average molecular weight=30×10⁴ g/mol)

This resin was produced according to a method described in Example 2 of WO 2019/142845.

P3HB3HH-30: P3HB3HH (average content ratio 3HB/3HH=70.5/29.5 (mol %/mol%), weight-average molecular weight=64×10⁴ g/mol)

This resin was produced according to a method described in Example 9 of WO 2019/142845.

P3HB3HH-13: P3HB3HH (Kaneka Biodegradable Polymer PHBH™, average content ratio 3HB/3HH=87.1/12.9 (mol %/mol%), weight-average molecular weight=33 ×10⁴ g/mol)

### Additives

Additive-1: Behenamide (BNT-22H, manufactured by Nippon Fine Chemical Co., Ltd.

Additive-2: Erucamide (NEUTRON-S, manufactured by Nippon Fine Chemical Co., Ltd.)

### Plasticizer

Plasticizer: Glycerin diacetomonolaurate (BIOCIZER, manufactured by Riken Vitamin Co., Ltd.)

The following describes evaluation methods used in Examples and Comparative Examples.

### Method for Evaluating Tube Moldability

The cylinder temperature and die temperature of a 50-mm-diameter single-screw extruder, to which an annular die (outer diameter=15 mm, inner diameter=13.5 mm) was coupled, were set to 150° C. Resin composition pellets were placed into the extruder and extruded into a tube. The extruded tube was passed through a 40° C. water bath located 100 mm away from the annular die and was then hauled off by a haul-off machine at a speed of 60 m/min. The molding was initially performed at a given molding speed and, after the molding was able to be continued for 5 minutes or more, the molding speed was increased by 5 m/min. The rating “successful molding” was given when the molding was able to last for 5 minutes or more after the increase of the molding speed, while the rating “unsuccessful molding” was given when the molding became difficult to continue within less than 5 minutes after the increase of the molding speed. The rating “cutting failure” was given when cutting failure occurred, even if the molding was able to be continued for 5 minutes or more at each molding speed.

Good: successful molding, Average: cutting failure, Poor: unsuccessful molding

### Method for Evaluating Gels in Tube

One hundred molded tubes cut to a length of 200 mm were collected, and these tubes were visually inspected to evaluate the size of gels (presumably crystallized PHA) contained in the tubes. The rating “poor” was given when gels having a diameter of 5 mm or more were found, the rating “average” was given when gels having a diameter of 1 to less than 5 mm were found, and the rating “good” was given when any gels having a diameter of 1 mm or more were not found.

### Example 1

An amount of 0.18 kg of PHB, 1.084 kg of P3HB3HH-3, 0.388 kg of P3HB3HH-30, and 0.35 kg of P3HB3HH-13 were blended to give resin proportions shown in Table 1. To the blend were added 20 g of Additive-1, 10 g of Additive-2, and 86 g of the plasticizer, and the blend, the additives, and the plasticizer were further blended.

The resulting resin material (resin mixture) was placed into and extruded by a 26-mm-diameter corotating twin-screw extruder whose cylinder temperature and die temperature were set to 150° C. The extruded resin material in the shape of a strand was passed through a water bath filled with 40° C. hot water to solidify the strand, which was cut by a pelletizer to obtain resin composition pellets.

The cylinder temperature and die temperature of a 50-mm-diameter single-screw extruder, to which an annular die (outer diameter=15 mm, inner diameter=13.5 mm) was coupled, were set to 150° C. The resin composition pellets were placed into the extruder and extruded into a tube. The extruded tube was passed through a 40° C. water bath located 100 mm away from the annular die and was then hauled off by a haul-off machine at a speed of 60 m/min. Thus, resin tubes having an outer diameter of 6 mm, a wall thickness of 0.2 mm, and a length of 200 mm were successfully obtained. After the molding was able to be continued for 5 minutes or more, the molding speed was increased by 5 m/min to evaluate moldability at a speed of 65 m/min.

The tubes molded at a speed of 60 m/min were subjected to the gel evaluation. No gels having a diameter of 1 mm or more were found.

The results of the tube moldability evaluation and the gel evaluation are summarized in Table 1.

### Examples 2 to 11 and Comparative Examples 1 to 3

Resin composition pellets were prepared in the same manner as in Example 1, except that the component proportions were changed as shown in Table 1. The resin composition pellets were subjected to the evaluations as performed in Example 1. The results are summarized in Table 1.

TABLE 1

| | | Ex. 1 | Ex. 2 | Ex. 3 | Ex. 4 | Ex. 5 | Ex. 6 | Ex. 7 | Ex. 8 |
|---|---|---|---|---|---|---|---|---|---|
| Resin | PHB | 9.0 | 11.2 | 11.9 | 12.1 | 12.1 | 12.1 | 12.1 | 12.1 |
| | (A) P3HB3HH-3 | 54.2 | 52.4 | 51.8 | 55.4 | 53.5 | 51.7 | 49.8 | 48.0 |
| | (B) P3HB3HH-30 | 19.4 | 19.4 | 19.6 | 12.9 | 16.1 | 19.4 | 22.6 | 25.8 |
| | (C) P3HB3HH-13 | 17.5 | 17.0 | 16.8 | 19.6 | 18.2 | 16.9 | 15.5 | 14.1 |
| Additive | Additive-1 | 1 | 1 | 1 | 1 | 1 | 1 | 1 | 1 |
| | Additive-2 | 0.5 | 0.5 | 0.5 | 0.5 | 0.5 | 0.5 | 0.5 | 0.5 |
| Plasticizer | | 4.3 | 4.3 | 4.3 | 4.3 | 4.3 | 4.3 | 4.3 | 4.3 |
| Amount of (A)/amount of (B) | | 2.8 | 2.7 | 2.6 | 4.3 | 3.3 | 2.7 | 2.2 | 1.9 |
| Amount of plasticizer/[amount of (B) + amount of | | 18 | 18 | 18 | 25 | 21 | 18 | 16 | 14 |
| plasticizer] (%) | | | | | | | | | |
| Moldability | At molding speed of 60 m/min | Good | Good | Good | Good | Good | Good | Good | Good |
| | At molding speed of 65 m/min | Average | Good | Good | Good | Good | Good | Good | Good |
| Gel evaluation | Size | Good | Good | Good | Good | Good | Good | Good | Good |
| | | (Small) | (Small) | (Small) | (Small) | (Small) | (Small) | (Small) | (Small) |

| | | Ex. 9 | Ex. 10 | Ex. 11 | Comp. 1 | Comp. 2 | Comp. 3 |
|---|---|---|---|---|---|---|---|
| Resin | PHB | 12.1 | 12.5 | 13.0 | 4.5 | 13.5 | 14.2 |
| | (A) P3HB3HH-3 | 46.1 | 51.3 | 51.0 | 57.9 | 50.6 | 50.3 |
| | (B) P3HB3HH-30 | 29.0 | 19.4 | 19.3 | 19.4 | 19.2 | 19.0 |
| | (C) P3HB3HH-13 | 12.8 | 16.7 | 16.7 | 18.3 | 16.6 | 16.6 |
| Additive | Additive-1 | 1 | 1 | 1 | 1 | 1 | 1 |
| | Additive-2 | 0.5 | 0.5 | 0.5 | 0.5 | 0.5 | 0.5 |
| Plasticizer | | 4.3 | 4.3 | 4.3 | 4.3 | 4.3 | 4.3 |
| Amount of (A)/amount of (B) | | 1.6 | 2.6 | 2.6 | 3.0 | 2.6 | 2.6 |
| Amount of plasticizer/[amount of (B) + amount of | | 13 | 18 | 18 | 18 | 18 | 18 |
| plasticizer] (%) | | | | | | | |
| Moldability | At molding speed of 60 m/min | Good | Good | Good | Poor | Good | Good |
| | At molding speed of 65 m/min | Good | Good | Good | Poor | Good | Good |
| Gel evaluation | Size | Good | Good | Average | Good | Poor | Poor |
| | | (Small) | (Small) | (Middle) | (Small) | (Large) | (Large) |

Table 1 reveals the following findings. In Examples 1 to 11, resin tubes containing no large gels and having a good appearance were successfully molded at high speeds of 60 m/min and 65 m/min.

In contrast, in Comparative Example 1, high-speed resin tube molding was difficult due to the excessively small amount of PHB (poly(3-hydroxybutyrate)).

In Comparative Examples 2 and 3, in which the amount of PHB was large, high-speed molding was feasible, but large-sized gels were observed in the molded resin tubes.

1. A resin tube comprising poly(3-hydroxybutyrate) and a poly(3-hydroxyalkanoate) copolymer, wherein an amount of the poly(3-hydroxybutyrate) is from 7 to 13 wt % based on 100 wt % of a total amount of the poly(3-hydroxybutyrate) and the poly(3-hydroxyalkanoate) copolymer.

2. The resin tube according to claim 1, wherein the poly(3-hydroxyalkanoate) copolymer comprises a copolymer (A) which is a copolymer of 3-hydroxybutyrate units and other hydroxyalkanoate units and in which a proportion of the other hydroxyalkanoate units in a total amount of the 3-hydroxybutyrate units and the other hydroxyalkanoate units is from 1 to 5 mol %.

3. The resin tube according to claim 2, wherein the poly (3-hydroxyalkanoate) copolymer further comprises a copolymer (B) which is a copolymer of 3-hydroxybutyrate units and other hydroxyalkanoate units and in which a proportion of the other hydroxyalkanoate units in a total amount of the 3-hydroxybutyrate units and the other hydroxyalkanoate units is at least 24 mol %.

4. The resin tube according to claim 2, wherein the poly(3-hydroxyalkanoate) copolymer further comprises a copolymer (C) which is a copolymer of 3-hydroxybutyrate units and other hydroxyalkanoate units and in which a proportion of the other hydroxyalkanoate units in a total amount of the 3-hydroxybutyrate units and the other hydroxyalkanoate units is from 6 to less than 24 mol %.

5. The resin tube according to claim 3, wherein a value obtained by dividing a weight fraction of the copolymer (A) in the total amount of the poly(3-hydroxybutyrate) and the poly(3-hydroxyalkanoate) copolymer by a weight fraction of the copolymer (B) in the total amount is from 1.5 to 4.5.

6. The resin tube according to claim 1, further comprising a plasticizer.

7. The resin tube according to claim 6, wherein a proportion of the plasticizer to a total amount of the copolymer (B) and the plasticizer is from 12 to 30 wt %.

8. The resin tube according to claim 6, wherein the plasticizer is a modified glycerin compound.

9. The resin tube according to claim 1, wherein the resin tube has a wall thickness of from 0.01 to 0.6 mm.

10. The resin tube according to claim 1, wherein the resin tube has a wall thickness of from 0.7 to 10 mm.

11. The resin tube according to claim 1, wherein the amount of the poly(3-hydroxybutyrate) is from 8 to 12.5 wt % based on 100 wt % of a total amount of the poly(3-hydroxybutyrate) and the poly(3-hydroxyalkanoate) copolymer.

12. The resin tube according to claim 1, wherein the amount of the poly(3-hydroxybutyrate) is from 9 to 13 wt % based on 100 wt % of a total amount of the poly(3-hydroxybutyrate) and the poly(3-hydroxyalkanoate) copolymer.

13. The resin tube according to claim 2, wherein in the copolymer (A), the proportion of the other hydroxyalkanoate units the total amount of the 3-hydroxybutyrate units and the other hydroxyalkanoate units is from 2 to 4 mol %.

14. The resin tube according to claim 1, wherein an average content ratio of the 3-hydroxybutyrate units and the other hydroxyalkanoate units, 3-hydroxybutyrate units/other hydroxyalkanoate units, in a total monomer units constituting the total poly(3-hydroxyalkanoate) resin contained in the resin tube is from 93/7 to 80/20 mol %/mol %.

15. The resin tube according to claim 3, wherein in the copolymer (B), the proportion of the other hydroxyalkanoate units in the total amount of the 3-hydroxybutyrate units and the other hydroxyalkanoate units is from 24 to 50 mol %.

16. The resin tube according to claim 2, wherein the copolymer (A) is poly(3-hydroxybutyrate-co-3-hydroxyhexanoate) or poly(3-hydroxybutyrate-co-4-hydroxybutyrate).

17. The resin tube according to claim 2, wherein the copolymer (B) is poly(3-hydroxybutyrate-co-3-hydroxyhexanoate) or poly(3-hydroxybutyrate-co-4-hydroxybutyrate).

18. The resin tube according to claim 5, wherein the value obtained by dividing the weight fraction of the copolymer (A) in the total amount of the poly(3-hydroxybutyrate) and the poly (3-hydroxyalkanoate) copolymer by the weight fraction of the copolymer (B) in the total amount is from 2.0 to 4.0.

19. The resin tube according to claim 4, wherein in the copolymer (C), the proportion of the other hydroxyalkanoate units in the total amount of the 3-hydroxybutyrate units and the other hydroxyalkanoate units is from 6 to 15 mol %.

20. The resin tube according to claim 3, wherein
the poly(3-hydroxyalkanoate) copolymer further comprises a copolymer (C) which is a copolymer of 3-hydroxybutyrate units and other hydroxyalkanoate units and in which a proportion of the other hydroxyalkanoate units in a total amount of the 3-hydroxybutyrate units and the other hydroxyalkanoate units is from 6 to less than 24 mol %, and
a proportion of the copolymer (C) to the total amount of the copolymers (A), (B), and (C) is from 5 to 45 wt %
